(19) United States
(12) Patent Application Publication
(10) Pub. No.: US 2011/0037841 A1
(43) Pub. Date: Feb. 17, 2011

(54) OPTICAL OBSERVATION SYSTEM

(75) Inventor: Yuichi SHIBASAKI, Saitama (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/850,901

(22) Filed: Aug. 5, 2010

(30) Foreign Application Priority Data
Aug. 12, 2009 (JP) 2009-187144

(51) Int. Cl. H04N 7/18

(52) U.S. Cl. 348/68; 348/E07.085

(57) ABSTRACT

An optical observation system is provided that includes a vibrator vibrating an emission end of an optical fiber such that light emitted from the emission end is scanned to depict a scanning trajectory having a distribution, within a predetermined scanning range on a subject, which distribution varies in response to a predetermined operation of an operation unit, a reflected light detector detecting reflected light from the subject scanned with the light emitted from the emission end, an image signal detector detecting image signals generated based on the reflected light at respective detection moments, a pixel allocation unit allocating pieces of image data created from the detected image signals into pixel addresses based on the detection moments, respectively, and an image generator generating the image of the subject with the pieces of image data allocated into the respective pixel addresses.

### BACKGROUND OF THE INVENTION

The following description relates to one or more optical observation systems configured to generate an observation image by optically scanning a subject to be observed, particularly to one or more medical observation systems having a scanning medical probe configured to acquire an image by optically scanning a subject to be observed while resonating a distal end of an extra-fine optical fiber.

As a medical devices used for an operator to examine in vivo tissue of an examinee, a fiberscope and an electronic scope have generally been known. For instance, an operator of an electronic scope inserts an insertion unit of the electronic scope and introduces a distal end of the insertion unit to a position close to a subject to be observed. The operator operates an operation unit of the electronic scope or a video processor as needed, and illuminates the subject with light emitted by a light source. Then, the operator takes a reflected-light image of the illuminated subject with a solid image sensor such as a charge coupled device (CCD) that is incorporated in the distal end of the insertion unit. The operator performs medical diagnosing or medical operations while observing the taken image of the subject through a monitor device.

The displayed image size of the subject varies e.g., depending on a sensor-to-subject distance and/or an actual size of the subject. In the case of a long sensor-to-subject distance and/or a small subject, the displayed image size of the subject is generally small. Some of such electronic scopes have a zooming function for displaying the image of the subject in an optically enlarged manner (e.g., see Japanese Patent Provisional Publication No. HEI 10-99261). Thus, the operator can examine the subject in a detailed and fine fashion by displaying the subject on a screen in an enlarged manner.

### SUMMARY OF THE INVENTION

In the electronic scope having the zooming function, an image-taking range becomes narrow as an image-taking magnification rises. Therefore, the subject is likely to be easily out of a frame due to slight movements of the electronic scope and/or the subject itself, despite the intention of the operator. In this case (i.e., the subject out of the frame), the operator has to once widen the image-taking range through zooming out, search the subject, and again zoom in the found subject. Such operations are too troublesome for the operator to implement smooth medical diagnosing.

The subject to be observed is not always in the center of the image-taking range. For instance, when a large intestine is examined, a subject to be observed is located at an intestinal wall which is displayed in a peripheral boarder region of the image-taking range. In this case, the operator has to perform troublesome operations of directing the distal end of the insertion unit of the electronic scope and exactly locating the subject in the center of the image-taking range.

Aspects of the present invention are advantageous to provide one or more improved configurations for an optical observation system that make it possible to observe a subject in a detailed manner without forcing an operator to perform any troublesome operation.

According to aspects of the present invention, an optical observation system is provided that is configured to generate an image of a subject by optically scanning the subject. The optical observation system includes a light source configured to emit light, an optical fiber configured to transmit therethrough the light emitted by the light source and emit the light from an emission end thereof, an operation unit, a vibrator configured to, in response to the operation unit being operated in a predetermined manner, vibrate the emission end of the optical fiber such that the light emitted from the emission end is scanned to depict a scanning trajectory having a distribution within a predetermined scanning range on the subject, the distribution varying depending on the predetermined manner in which the operation unit is operated, a reflected light detector configured to detect reflected light from the subject that is scanned with the light emitted from the emission end of the optical fiber, an image signal detector configured to detect image signals generated based on the reflected light, at respective detection moments, a pixel allocation unit configured to allocate pieces of image data created from the detected image signals into pixel addresses, based on the detection moments when the image signals are detected, respectively, and an image generator configured to generate the image of the subject with the pieces of image data allocated into the respective pixel addresses.

Optionally, the vibrator may be configured to, in response to the operation unit being operated in a first manner, vibrate the emission end of the optical fiber such that the light emitted from the emission end is scanned to depict a scanning trajectory that is distributed evenly within the predetermined scanning range on the subject.

Still optionally, the vibrator may be configured to, in response to the operation unit being operated in a second manner different from the first manner, vibrate the emission end of the optical fiber such that the light emitted from the emission end is scanned to depict a scanning trajectory that is distributed with a higher density toward a center of the predetermined scanning range on the subject.

Further optionally, the vibrator may be configured to, in response to the operation unit being operated in a third manner different from the first and second manners, vibrate the emission end of the optical fiber such that the light emitted from the emission end is scanned to depict a scanning trajectory that is distributed with a higher density toward a peripheral boarder region of the predetermined scanning range on the subject.

Optionally, the vibrator may be configured to, in response to the operation unit being operated in the predetermined manner, vibrate the emission end of the optical fiber such that the emission end revolves around an axis line direction of the optical fiber so as to depict a spiral pattern on a plane perpendicular to the axis line direction with a revolution radius increasing at a predetermined rate during a scanning period in which the light emitted from the emission end is scanned within the predetermined scanning range on the subject.

Yet optionally, the vibrator may be configured to, in response to the operation unit being operated in the first manner, vibrate the emission end of the optical fiber such that the emission end revolves around an axis line direction of the optical fiber so as to depict a spiral pattern on a plane perpendicular to the axis line direction with a revolution radius increasing at a constant rate during a scanning period in which the light emitted from the emission end is scanned within the predetermined scanning range on the subject.

Still optionally, the vibrator may configured to, in response to the operation unit being operated in the second manner, vibrate the emission end of the optical fiber such that the emission end revolves around an axis line direction of the optical fiber so as to depict a spiral pattern on a plane perpendicular to the axis line direction with a revolution radius increasing at an exponential rate during a scanning period in which the light emitted from the emission end is scanned within the predetermined scanning range on the subject.

Further optionally, the vibrator may be configured to, in response to the operation unit being operated in the third manner, vibrate the emission end of the optical fiber such that the emission end revolves around an axis line direction of the optical fiber so as to depict a spiral pattern on a plane perpendicular to the axis line direction with a revolution radius increasing at a logarithmic rate during a scanning period in which the light emitted from the emission end is scanned within the predetermined scanning range on the subject.

Optionally, a maximum value of the revolution radius with which the emission end of the optical fiber is revolved by the vibrator during the scanning period may be constant regardless of variation of the distribution of the scanning trajectory.

Optionally, the predetermined scanning range within which the light emitted from the emission end of the optical fiber is scanned on the subject may be constant regardless of variation of the distribution of the scanning trajectory.

Optionally, the vibrator may include a piezoelectric actuator disposed near the emission end of the optical fiber, and a driver configured to control a voltage to be applied to the piezoelectric actuator in response to the operation unit being operated in the predetermined manner.

### BRIEF DESCRIPTION OF THE ACCOMPANYING DRAWINGS

FIG. 1 schematically shows a configuration of a medical observation system in an embodiment according to one or more aspects of the present invention.

FIG. 2 is a block diagram showing a configuration of a processor for the medical observation system in the embodiment according to one or more aspects of the present invention.

FIG. 3 is a cross-sectional side view schematically showing an internal configuration of an insertion distal end of an insertion flexible unit for the medical observation system in the embodiment according to one or more aspects of the present invention.

FIG. 4 is a perspective view schematically showing the internal configuration of the insertion distal end of the insertion flexible unit for the medical observation system in the embodiment according to one or more aspects of the present invention.

FIG. 5 is an illustration for explaining spots formed on a subject to be observed using the medical observation system in the embodiment according to one or more aspects of the present invention.

FIG. 6 is an illustration for explaining a relationship between image signals detected at each timing and a pixel address in the embodiment according to one or more aspects of the present invention.

FIG. 7 is a flowchart showing a resolution distribution changing process to be executed in the embodiment according to one or more aspects of the present invention.

FIGS. 8A to 8C are graphs showing changes in a revolution amplitude (i.e., a revolution radius) of an emission end of a single-mode fiber in one frame based on respective different amplitude defining functions in the embodiment according to one or more aspects of the present invention.

FIGS. 9A and 9B exemplify respective images of different subjects displayed on a monitor of the medical observation system in the embodiment according to one or more aspects of the present invention.

FIGS. 10A and 10B exemplify respective images of the different subjects displayed in an enlarged manner on the monitor of the medical observation system in the embodiment according to one or more aspects of the present invention.

### DETAILED DESCRIPTION OF THE EMBODIMENTS

It is noted that various connections are set forth between elements in the following description. It is noted that these connections in general and, unless specified otherwise, may be direct or indirect and that this specification is not intended to be limiting in this respect. Aspects of the invention may be implemented in computer software as programs storable on computer-readable media including but not limited to RAMs, ROMs, flash memories, EEPROMs, CD-media, DVD-media, temporary storage, hard disk drives, floppy drives, permanent storage, and the like.

Hereinafter, an embodiment according to aspects of the present invention will be set forth with reference to the accompanying drawings.

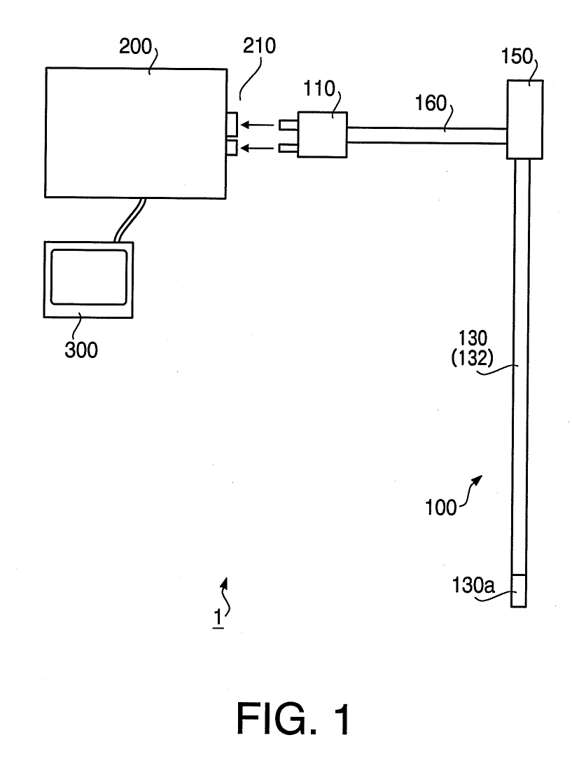

FIG. 1 schematically shows a configuration of a medical observation system 1 in the embodiment. As illustrated in FIG. 1, the medical observation system 1 includes a scanning medical probe 100. The scanning medical probe 100 includes an insertion flexible unit 130 with a flexible sheath 132 covered therearound. An operator inserts the insertion flexible unit 130 directly into a body cavity from a side of a distal end (hereinafter referred to as an insertion distal end 130a) of the insertion flexible unit 130, and introduces the insertion distal end 130a to a position close to a subject. Alternatively, in order to introduce the insertion distal end 130a to a position close to the subject, the insertion flexible unit 130 may be inserted into the body cavity with a guide wire attached thereto. Furthermore, the operator may insert the insertion flexible unit 130, e.g., into a forceps channel of a general electronic scope having a solid image sensor, and operates the insertion distal end 130a to be close to the subject.

At a base end of the insertion flexible unit 130, an operation unit 150 is provided for operating the scanning medical probe 100. A connector 110 is provided at a base end of a universal cable 160 extending from the operation unit 150.

The medical observation system 1 includes a processor 200. The processor 200 is provided integrally with a signal processor and a light source incorporated therein. The signal processor controls the scanning medical probe 100 and generates an image signal based on observation light acquired through the scanning medical probe 100. The light source emits scanning light through the scanning medical probe 100 to illuminate in vivo tissue, which is not generally illuminated with natural light. It is noted that the signal processor and the light source may separately be provided. The processor 200 includes a connector 210. When the connector 110 is inserted into the connector 210, the scanning medical probe 100 is connected optically and electrically with the processor 200.

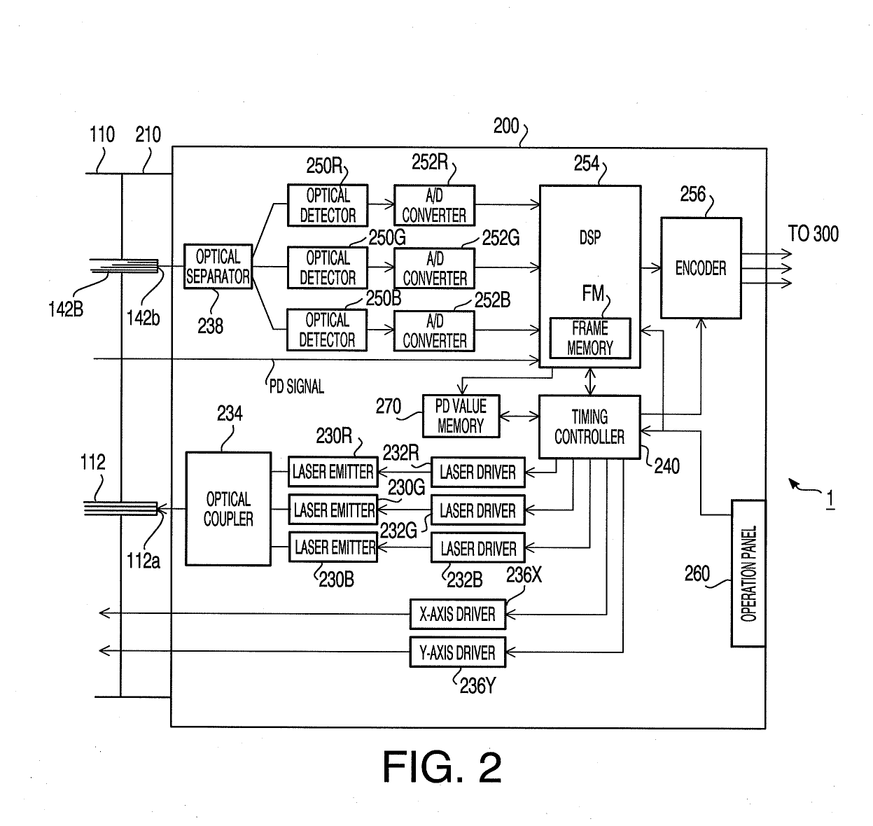

FIG. 2 is a block diagram showing a configuration of a processor 200. In FIG. 2, the connector 110 is schematically depicted as well to explicitly show a connection relationship between the scanning medical probe 100 and the processor 200.

The processor 200 includes laser emitters 230R, 230G, and 230B as the light source for scanning the subject, which laser emitters emit laser beams having wavelengths R, G, and B, respectively. It is noted that the three laser emitters 230R, 230G, and 230B may be replaced, e.g., with a single fiber laser that emits supercontinuum light having a wide wavelength range. Further, the laser emitters 230R, 230G, and 230B may be replaced, e.g., with light emitting diodes (LEDs).

The processor 200 includes a timing controller 240 that takes overall control of a signal processing timing for each circuit of the processor 200. The timing controller 240 transmits a predetermined modulation control signal to each driver circuit for laser drivers 232R, 232G, and 232B. The laser drivers 232R, 232G, and 232B directly modulate the laser emitters 230R, 230G, and 230B based on the received modulation control signals, respectively. Specifically, each driver circuit conveys an electric current having the same amplitude and the same phase to a corresponding one of the laser emitters 230R, 230G, and 230B based on the modulation control signal. Thereby, the laser emitters 230R, 230G, and 230B emit pulse laser beams (hereinafter referred to as a “R pulse laser beam,” a “G pulse laser beam,” and a “B pulse laser beam”) with the same intensity, which pulse laser beams correspond to the wavelengths R, G, and B, respectively, in synchronization with each other.

The R pulse laser beam, the G pulse laser beam, and the B pulse laser beam, which are emitted by the laser emitters 230R, 230G, and 230B, are introduced into an optical coupler 234. The optical coupler 234 emits the received pulse laser beams, coupled in a coherent state. Hereinafter, for the sake of simplicity in explanation, the pulse laser beams coupled by the optical coupler 234 will be referred to as a coupled pulse laser beam.

When the light source is configured with a single fiber laser, the timing control is unnecessary to synchronize the pulse laser beams that has the wavelengths R, G, and B, respectively. Therefore, a configuration for circuits disposed around the laser emitters 230R, 230G, and 230B may be simplified. In addition, since the pulse laser beams are emitted in a coupled state, the optical coupler 234 may be omitted.

The coupled pulse laser beam emitted by the optical coupler 234 is incident onto an incidence end 112a of a single-mode optical fiber 112 included in the scanning medical probe 100. The single-mode fiber 112 is housed in the sheath 132 over its length from the connector 110 to the insertion distal end 130a. The coupled pulse laser beam incident onto the incidence end 112a is transmitted through the single-mode fiber 112 while repeating total internal reflection within the single-mode fiber 112.

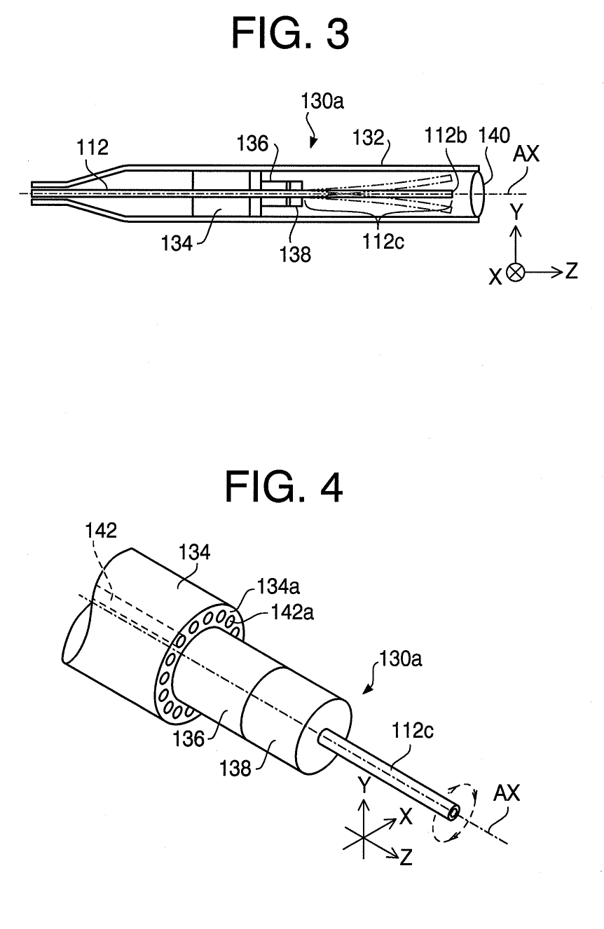

FIG. 3 is a cross-sectional side view schematically showing an internal configuration of the insertion distal end 130a. FIG. 4 is a perspective view schematically showing the internal configuration of the insertion distal end 130a. Hereinafter, for the sake of simplicity in explanation about the configuration of the scanning medical probe 100, the longitudinal direction of the scanning medical probe 100 will be defined as a Z-axis, and two directions, which are perpendicular to the Z-axis and perpendicular to one another, will be defined as an X-axis and a Y-axis. According to the definitions, for example, FIG. 3 is a cross-sectional view of the insertion distal end 130a along the Y-Z plane containing a central axis AX of the scanning medical probe 100.

As depicted in FIGS. 1 and 3, the outer diameter of the insertion flexible unit 130 is determined by the outer diameter of the sheath 132. Since the scanning medical probe 100 is configured without any solid image sensor incorporated therein, the sheath 132 has an outer diameter smaller than that of a general electronic scope. Therefore, the scanning medical probe 100 attains a lower level of invasiveness than that of a general electronic scope.

As shown in FIG. 3, a supporter 134 is provided inside the sheath 132. A distal end portion 112c of the single-mode fiber 112 is inserted into a through hole of the supporter 134 and supported by the supporter 134 to be cantilevered. The supporter 134 also supports piezoelectric actuators 136 and 138. A terminal end of each electrode of the piezoelectric actuators 136 and 138 is connected with an electric wire (not shown) housed in the connector 110. When the connector 110 is connected with the connector 210, the piezoelectric actuators 136 and 138 are connected with an X-axis driver 236X and a Y-axis driver 236Y of the processor 200 via the electric wires, respectively.

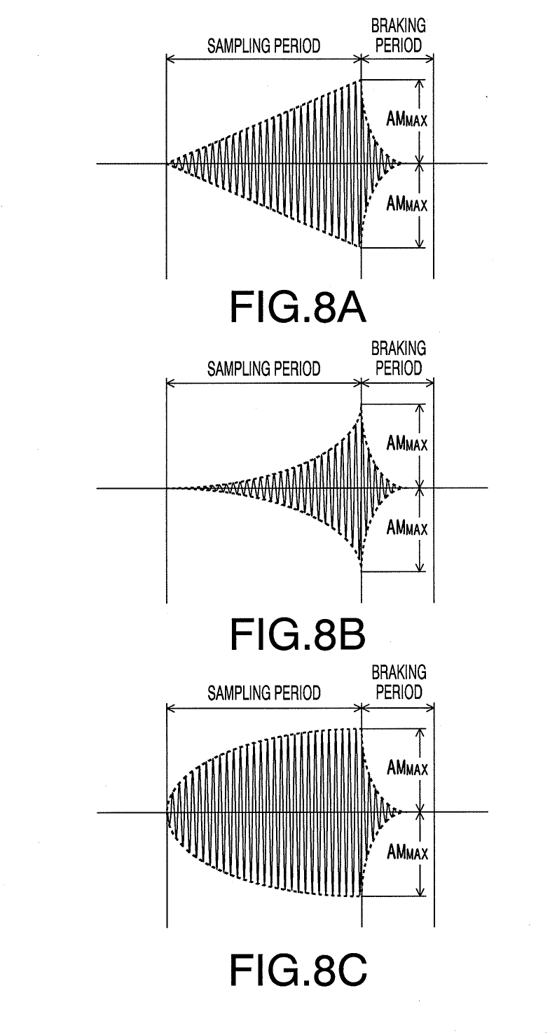

The timing controller 240 transmits a predetermined driver control signal to each driver circuit of the X-axis driver 236X and the Y-axis driver 236Y. The X-axis driver 236X applies an alternating voltage X to the piezoelectric actuator 136 based on the corresponding driver control signal. The Y-axis driver 236Y applies an alternating voltage Y, which has the same frequency as that of the alternating voltage X and a phase different from that of the alternating voltage X by 90 degrees, to the piezoelectric actuator 138 based on the corresponding driver control signal. It is noted that the alternating voltage X is defined as a voltage with an amplitude gradually rising at a predetermined rate (see FIG. 8A) to reach an efficient value (X) over a predetermined time period (X). Further, the alternating voltage Y is defined as a voltage with an amplitude gradually rising at a predetermined rate (see FIG. 8A) to reach an efficient value (Y) over a predetermined time period (Y).

The piezoelectric actuators 136 and 138 are configured with appropriately selected materials and shapes so as to resonate with each other when the alternating voltages X and Y are applied thereto, respectively. An emission end 112b of the single-mode fiber 112 revolves around the central axis AX so as to depict a spiral pattern on an approximate plane of the X-Y plane (hereinafter referred to as an XY approximate plane) when kinetic energies generated by the piezoelectric actuators 136 and 138 in the X-axis direction and the Y-axis direction are combined. The revolving trajectory of the emission end 112b expands radially in proportion to the applied voltages X and Y, so as to depict a circular trajectory with the largest radius at the moment when the alternating voltages X and Y of the efficient values (X) and (Y) are respectively applied to the piezoelectric actuators 136 and 138.

The coupled pulse laser beam incident onto the incidence end 112a of the single-mode fiber 112 is kept to be emitted by the emission end 112b during a time period until the application of the alternating voltages X and Y to the piezoelectric actuators 136 and 138 is terminated immediately after the application of the alternating voltages X and Y is started (i.e., a time period equivalent to the timer period (X) or (Y)). Hereinafter, for the sake of descriptive convenience, the time period will be referred to as a “sampling period.”

After lapse of the sampling period, the application of the alternating voltages X and Y to the piezoelectric actuators 136 and 138 is terminated, and thereby the vibration of the distal end portion 112c of the single-mode fiber 112 is attenuated. The circular movement of the emission end 112b on the XY approximate plane recedes along with the attenuation of the vibration of the distal end portion 112c of the single-mode fiber 112, and stops on the central axis AX after a predetermined time period. Hereinafter, for the sake of descriptive convenience, a time period until the circular movement of the emission end 112b stops on the central axis AX after lapse of the sampling period (more exactly, a time period that is set to be slightly longer than a calculated time period until the circular movement of the emission end 112b stops on the central axis AX after lapse of the sampling period, in order to assure the stop of the circular movement of the emission end 112b on the central axis AX) will be referred to as a braking period. A time period corresponding to one frame is configured with the sampling period and the braking period. It is noted that in order to shorten the braking period, a braking torque may actively be applied by applying a voltage with a reversed phase to each of the piezoelectric actuators 136 and 138 at an initial stage during the braking period.

A converging optical system 140 is disposed in front of the emission end 112b of the single-mode fiber 112. The converging optical system 140 is depicted as a single lens in FIG. 3. However, the converging optical system 140 may be configured with a plurality of lenses. In front of the converging optical system 140, a cover glass CG is disposed to seal the sheath 132. The coupled pulse laser beam, emitted by the emission end 112b of the single-mode fiber, is converged through the converging optical system 140 to form spots Si on the subject. Each spot Si has a very small diameter, e.g., of several micrometers order

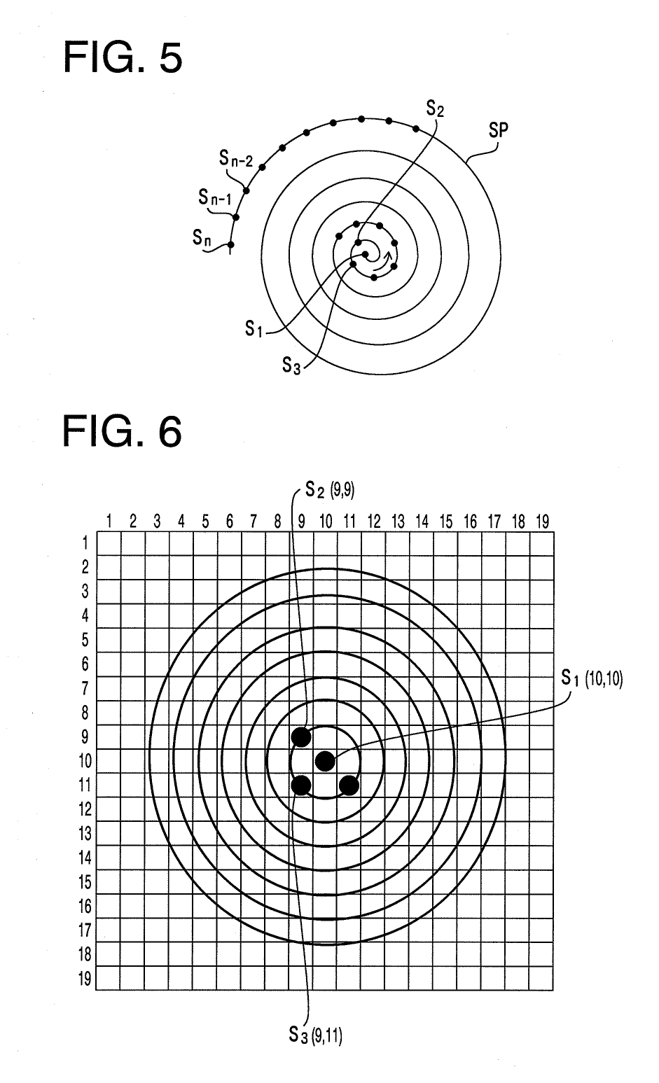

FIG. 5 is an illustration for explaining the spots Si (i=1 to n) formed on the subject. In order to acquire a sheet of image, the scanning medical probe 100 forms n-pieces of spots Si in the order of “S₁, S₂, S₃, . . . , Sₙ₋₂, Sₙ₋₁, Sₙ” while depicting a spiral pattern SP on the subject. The distance between each adjacent two of the spots Si is determined depending on a moving velocity of the emission end 112b of the single-mode fiber 112 and/or a modulation frequency of each of the laser emitters 230R, 230G, and 230B. It is noted that the spiral pattern SP is a virtual scanning trajectory depicted based on an assumption that the subject is scanned with a continuous laser beam instead of a pulse laser beam.

The positions (trajectory) of the emission end 112b of the single-mode fiber 112 on the XY approximate plane during the sampling period are previously determined through experiments. Further, the relationship is previously determined between the positions of the emission end 112b and the positions within the image-taking range (the scanning range) where the spots Si would be formed on the subject if the coupled pulse laser beam is emitted by the emission end 112b located in its determined positions. Based on the previously determined data, the timing controller 240 takes control of the X-axis driver 236X and the Y-axis driver 236Y (i.e., control of the alternating voltages applied to the piezoelectric actuators 136 and 138), and control of the laser drivers 232R, 232G, and 232B (i.e. modulation control of the laser drivers 232R, 232G, and 232B during the sampling period), repeatedly at intervals of a period corresponding to a frame rate.

As shown in FIG. 4, an end surface 134a of the supporter 134 is formed with a plurality of through holes arranged in an annular shape. A detection fiber 142 is inserted in each through hole. The detection fibers 142 are bundled behind the supporter 134 to constitute an optical fiber bundle 142B.

A reflected pulse laser beam of the laser beam that forms the spots Si on the subject is incident onto incidence ends 142a of the detection fibers 142. The reflected pulse laser beam incident onto the incidence ends 142a is transmitted through the optical fiber bundle 142B (the detection fibers 142) toward a terminal end of the optical fiber bundle 142B. The terminal end of the optical fiber bundle 142B is housed in the connector 110, and connected with an optical separator 238 of the processor 200 via a joint between the connector 110 and the connector 210.

It is noted that the fiber bundle 142B is configured just with several dozen optical fibers (e.g., 80 fibers) bundled. Therefore, the fiber bundle 142B has a smaller diameter than that of an optical fiber bundle (e.g., an optical fiber bundle configured with several hundreds to a thousand of optical fibers bundled) for a general electronic scope or a general fiber scope. Further, in the embodiment, the detection fibers 142 are not limited to a plurality of fibers, but may be a single fiber. In the case of a single detection fiber 142, it is possible to make smaller the diameter of the scanning medical probe 100.

The optical separator 238 separates the reflected pulse laser beam transmitted through the optical fiber bundle 142B into reflected pulse laser beams that has the wavelengths R, G, and B, respectively (hereinafter referred to as a reflected R pulse laser beam, a reflected G pulse laser beam, and a reflected B pulse laser beam). Then, the reflected R pulse laser beam, the reflected G pulse laser beam, and the reflected B pulse laser beam are transmitted to optical detectors 250R, 250G, and 250B, respectively.

As described above, the coupled pulse laser beam is transmitted through the single single-mode fiber 112 to illuminate the subject. Therefore, the optical intensity of the reflected pulse laser beam reflected on the subject is small. Thus, in order to certainly detect such a small intensity of light with a low level of noise, a highly-sensitive optical detector such as a photoelectron multiplier is adopted for each of the optical detectors 250R, 250G, and 250B.

Each of the optical detectors 250R, 250G, and 250B generates an analog signal through photoelectric conversion of the reflected pulse laser beam having a corresponding one of the wavelengths R, G, B, and then transmits the analog signal to a subsequent circuit. The analog signal, which corresponds to the reflected pulse laser beam having a corresponding one of the wavelengths R, G, and B that is detected by each of the optical detectors 250R, 250G, and 250B, is sampled, held, and converted into a digital signal sequence through a corresponding one of A/D converters 252R, 252G, and 252B. The digital signal sequence is transmitted to a digital signal processor (DSP) 254.

The DSP 254 has a conversion table created based on the aforementioned previously determined data. The conversion table associates the positions where the spots Si of the coupled pulse laser beam are formed within the image-taking range (in other words, addresses of pixels constituting a taken image) with a timing T when the pulse laser beams reflected by the spots Si are detected. Referring to the conversion table, the DSP 254 monitors the digital signal sequence from each of the A/D converters 252R, 252G, and 252B, and detects a signal corresponding to each wavelength at each timing T as an image signal at a corresponding pixel address. Namely, the DSP 254 detects a signal from the A/D converter 252R as a brightness value corresponding to the color (wavelength) R, a signal from the A/D converter 252G as a brightness value corresponding to the color (wavelength) G, and a signal from the A/D converter 252B as a brightness value corresponding to the color (wavelength) B. The DSP 254 buffers the detected image signals for each pixel address in a frame memory FM.

Referring to FIG. 6, a detailed explanation will be provided about a relationship between the image signals detected at each timing T and a pixel address. For the sake of descriptive convenience, it is assumed that a finally created image is configured with 19×19 pixels. Referring to the conversion table, the DSP 254 detects an image signal corresponding to each wavelength, at a timing T₁ corresponding to the spot S₁. The DSP 254 buffers, into the frame memory FM, the detected image signal corresponding to each wavelength in association with a pixel address (10, 10). The DSP 254 sequentially detects image signals corresponding to each wavelength at subsequent timings T₂, T₃, . . . corresponding to the spots S₂, S₃, . . . , and buffers into the frame memory FM the detected image signals corresponding to each wavelength in association with pixel addresses (9, 9), (9, 11), . . . , respectively. Thus, the DSP 254 buffers, in the frame memory FM, the image signals for one frame (all pixels) that correspond to the spots S₁ to Sₙ formed on the subject.

For a pixel address having no image signal to be associated therewith, for instance, the DSP 254 generates predetermined masking data and buffers the masking data in the frame memory FM. The DSP 254 reads out the image signals buffered in the frame memory FM and transmits the read image signals to an encoder 256, in accordance with the timing control by the timing controller 240.

The encoder 256 converts the image signals into video signals conforming to a predetermined standard, and transmits the video signals to a monitor 300. Thereby, a color image of the subject that is generated from the colors R, G. and B is displayed on the monitor 300. At this time, the resolution for the color image of the subject displayed on the monitor 300 is an initial resolution set when the medical observation system 1 is launched. The resolution is substantially even over a whole region from the center to the peripheral boarder region of the image-taking range (the scanning range).

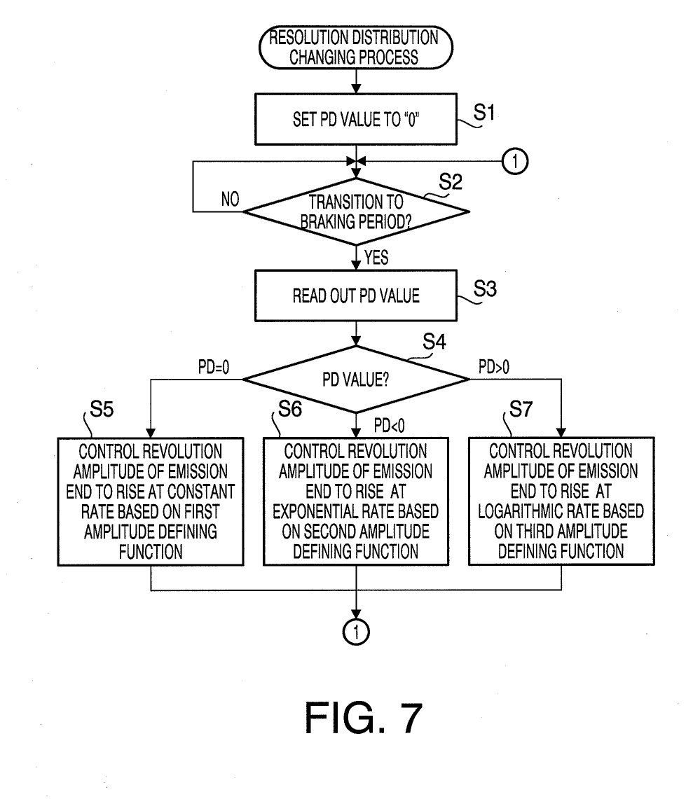

In the embodiment, the distribution of the resolution for a taken image is changed by an operation of pushing up/down a lever of the operation unit 150. FIG. 7 is a flowchart showing a resolution distribution changing process to be executed to change the distribution of the resolution for a taken image. The resolution distribution changing process is implemented continuously during a period from start to stop of the medical observation system 1.

Immediately after the medical observation system 1 is launched, the DSP 254 writes, into a PD value memory 270, an initial value (PD=0) for a PD value (S1). The PD value written in the PD value memory is updated in response to a lever of the operation unit 150 being operated by the operator while the medical observation system 1 is working. Specifically, the operation unit 150 issues, to the DSP 254, a PD signal depending on a lever operation time during which the lever is being pushed up/down. For example, the PD signal includes a signal indicating a pushing-up operation (of pushing up the lever) or a pushing-down operation (of pushing down the lever) and a pulse signal with pulses of a number proportional to the lever operation time. When receiving a PD signal corresponding to the pushing-up operation, the DSP 254 adds the number of the pulses included in the PD signal to the PD value stored in the PD value memory 270. Meanwhile, when receiving a PD signal corresponding to the pushing-down operation, the DSP 254 subtracts the number of the pulses included in the PD signal from the PD value stored in the PD value memory 270.

In S2, the DSP 254 determines whether transition from the sampling period to the braking period is detected, under the timing control by the timing controller 240 (S2). When detecting the transition to the braking period (S2: Yes), the DSP 254 reads out the PD value from the PD value memory 270 (S3), and performs operations in a subsequent step S4 and one of steps S5 to S7 until another sampling period for a next frame comes.

The DSP 254 holds various amplitude defining functions f in association with respective PD values, each of which amplitude defining functions f defines a revolution amplitude (i.e., a revolution radius) of the emission end 112b of the single-mode fiber 112 during the sampling period. When the PD value stored in the PD value memory 270 is zero (S4: PD=0), the DSP 254 calls out a first amplitude defining function f corresponding to the PD value equal to zero, and transmits the first amplitude defining function f to the timing controller 240. In S5, the timing controller 240 generates a drive control signal based on the first amplitude defining function f (S5). When another sampling period for a next frame has come, the timing controller 240 transmits the drive control signal generated in S5 to each driver circuit of the X-axis driver 236X and the Y-axis driver 236Y.

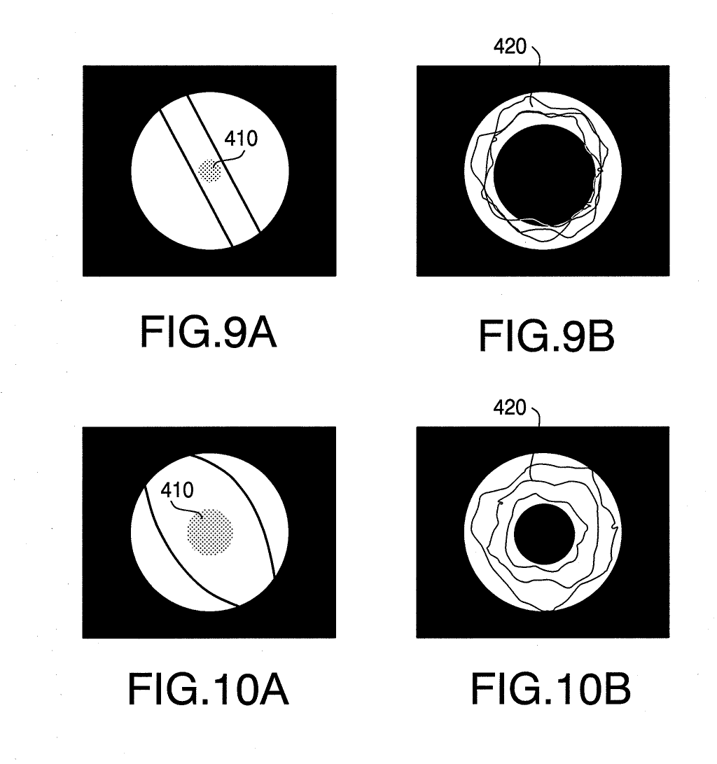

FIG. 8A is a graph showing a change in the revolution amplitude of the emission end 112b of the single-mode fiber 112 in one frame. In FIG. 8A, the vertical axis represents the revolution amplitude while the horizontal axis represents time. When receiving the drive control signal generated based on the first amplitude defining function f, the X-axis driver 236X and the Y-axis driver 236Y drive and control the piezoelectric actuators 136 and 138 such that as shown in FIG. 8A, during the sampling period, the revolution amplitude of the emission end 112b rises gradually at a predetermined rate until reaching the maximum amplitude AM_{MAX} (in other words, such that the revolving trajectory of the emission end 112b gradually expands in a radial direction at a predetermined constant rate). At this time, the n-pieces of spots Si formed on the subject are evenly distributed over the whole scanning range. FIG. 9A is an image of a bronchial tube taken when the revolution amplitude of the emission end 112b is controlled as shown in FIG. 8A. FIG. 9B is an image of a large intestine taken when the revolution amplitude of the emission end 112b is controlled as shown in FIG. 8A. A subject to be observed in the bronchial tube is attached with a reference number 410 in FIG. 9A. A subject (an intestine wall) to be observed in the large intestine is attached with a reference number 410 in FIG. 9B.

When the PD value stored in the PD value memory 270 is less than zero (S4: PD<0), the DSP 254 calls out a second amplitude defining function f corresponding to the PD value less than zero, and transmits the second amplitude defining function f to the timing controller 240. In S6, the timing controller 240 generates a drive control signal based on the second amplitude defining function f (S6). When another sampling period for a next frame has come, the timing controller 240 transmits the drive control signal generated in S6 to each driver circuit of the X-axis driver 236X and the Y-axis driver 236Y.

In the same manner as FIG. 8A, FIG. 8B shows a change in the revolution amplitude of the emission end 112b of the single-mode fiber 112 in one frame. When receiving the drive control signal generated based on the second amplitude defining function f, the X-axis driver 236X and the Y-axis driver 236Y drive and control the piezoelectric actuators 136 and 138 such that as shown in FIG. 8B, during the sampling period, the revolution amplitude of the emission end 112b rises gradually at an exponential rate until reaching the maximum amplitude AM_{MAX} (in other words, such that the revolving trajectory of the emission end 112b gradually expands in a radial direction at an exponential rate). At this time, the modulation control for each laser emitter during the sampling period is taken in the same manner as the control of the revolution amplitude as exemplified in FIG. 8A. Therefore, the n-pieces of spots Si formed on the subject are distributed with a higher density toward the center of the scanning range (in other words, with a lower density toward the peripheral boarder region of the scanning range). Further, the image of the subject is created in accordance with the same algorithm for allocating the pixels as that in the example shown in FIG. 8A using the aforementioned conversion table. Therefore, the image of the subject is displayed on the monitor 300 as an image with more pixels toward the center of the scanning range (i.e., with a higher resolution toward the center of the scanning range). In addition, the scanning range is the same as that for the revolution amplitude control as exemplified in FIG. 8A. Thus, the image-taking range is maintained to be the same as exemplified in FIG. 8A despite a higher resolution applied to the center of the subject image.

FIG. 10A is an image, of the same bronchial tube as shown in FIG. 9A, which is taken based on the revolution amplitude control as exemplified in FIG. 8B. Since the image of the subject is taken with more pixels toward the center of the image-taking range, the subject 410 can be displayed on the monitor 300 in an enlarged manner as shown in FIG. 10A. Therefore, the operator can perform detailed observation (medical diagnosing) of the subject 410. Further, the image-taking range in the example shown in FIG. 10A is maintained to be the same as that exemplified in FIG. 9A. Thus, the subject is less likely to be out of the frame due to slight movements of the scanning medical probe and/or the subject itself, in comparison with a case where an image-taking magnification is raised using a general zooming function.

It is noted that as the PD value is lower (i.e., as a lever operation time during which the lever of the operation unit 150 is being pushed down is longer), the revolution amplitude of the emission end 112b of the single-mode fiber 112 rises at a more significant exponential-rate during the sampling period. Accordingly, as the PD value is lower, the image of the subject is taken with a higher resolution toward the center of the image-taking range. Thus, the operator can perform more detailed observation (medical diagnosing) of an image in the center of the image-taking range.

When the PD value stored in the PD value memory 270 is more than zero (S4: PD>0), the DSP 254 calls out a third amplitude defining function f corresponding to the PD value more than zero, and transmits the third amplitude defining function f to the timing controller 240. In S7, the timing controller 240 generates a drive control signal based on the third amplitude defining function f (S7). When another sampling period for a next frame has come, the timing controller 240 transmits the drive control signal generated in S7 to each driver circuit of the X-axis driver 236X and the Y-axis driver 236Y.

In the same manner as FIG. 8A, FIG. 8C shows a change in the revolution amplitude of the emission end 112b of the single-mode fiber 112 in one frame. When receiving the drive control signal generated based on the third amplitude defining function f, the X-axis driver 236X and the Y-axis driver 236Y drive and control the piezoelectric actuators 136 and 138 such that as shown in FIG. 8C, during the sampling period, the revolution amplitude of the emission end 112b rises gradually at a logarithmic rate until reaching the maximum amplitude AM_{MAX} (in other words, such that the revolving trajectory of the emission end 112b gradually expands in a radial direction at a logarithmic rate). At this time, the modulation control for each laser emitter during the sampling period is taken in the same manner as the control of the revolution amplitude as exemplified in FIG. 8A. Therefore, the n-pieces of spots Si formed on the subject are distributed with a higher density toward the peripheral boarder region of the scanning range (in other words, with a lower density toward the center of the scanning range). Further, the image of the subject is created in accordance with the same algorithm for allocating the pixels as that in the example shown in FIG. 8A using the aforementioned conversion table. Therefore, the image of the subject is displayed on the monitor 300 as an image with more pixels toward the peripheral boarder region of the scanning range (i.e., with a higher resolution toward the peripheral boarder region of the scanning range). In addition, the scanning range is the same as that for the revolution amplitude control as exemplified in FIG. 8A. Thus, the image-taking range is maintained to be the same as exemplified in FIG. 8A despite a higher resolution applied to the peripheral boarder region of the subject image.

FIG. 10B is an image, of the same large intestine as shown in FIG. 9B, which is taken based on the revolution amplitude control as exemplified in FIG. 8B. Since the image of the subject is taken with more pixels toward the peripheral boarder region of the image-taking range, the subject 420 can be displayed on the monitor 300 in an enlarged manner as shown in FIG. 10B. Therefore, the operator can perform detailed observation (medical diagnosing) of the subject 420. Further, the image-taking range in the example shown in FIG. 10B is maintained to be the same as that exemplified in FIG. 9B. Thus, the subject is less likely to be out of the frame due to slight movements of the scanning medical probe and/or the subject itself, in comparison with a case where an image-taking magnification is raised using a general zooming function.

It is noted that as the PD value is higher (i.e., as a lever operation time during which the lever of the operation unit 150 is being pushed up is longer), the revolution amplitude of the emission end 112b of the single-mode fiber 112 rises at a more significant logarithmic-rate during the sampling period. Accordingly, as the PD value is higher, the image of the subject is taken with a higher resolution toward the peripheral boarder region of the image-taking range. Thus, the operator can perform more detailed observation (medical diagnosing) of an image in the peripheral boarder region of the image-taking range.

Thus, when the subject is displayed in an optically enlarged manner with the medical observation system 1 of the embodiment, the image-taking range is not reduced (i.e., the image-taking range is always identical). Therefore, the subject is less likely to be out of the frame due to slight movements of the scanning medical probe and/or the subject itself, and thus it can help the operator make smooth medical diagnosing. In addition, a subject in a peripheral boarder region in an image-taking range can be displayed in an enlarged manner without directing the insertion distal end 130a to the subject. Hence, it is possible to reduce an operational burden placed on the operator and to efficiently avoid unnecessary contact between the insertion distal end 130a and in-vivo tissue.

Hereinabove, the embodiment according to aspects of the present invention have been described. The present invention can be practiced by employing conventional materials, methodology and equipment. Accordingly, the details of such materials, equipment and methodology are not set forth herein in detail. In the previous descriptions, numerous specific details are set forth, such as specific materials, structures, processes, etc., in order to provide a thorough understanding of the present invention. However, it should be recognized that the present invention can be practiced without reapportioning to the details specifically set forth. In other instances, well known processing structures have not been described in detail, in order not to unnecessarily obscure the present invention.

An only exemplary embodiment of the present invention and but a few examples of its versatility are shown and described in the present disclosure. It is to be understood that the present invention is capable of use in various other combinations and environments and is capable of changes or modifications within the scope of the inventive concept as expressed herein.

For example, an interface for changing a resolution distribution for a taken image is not limited to the lever of the operation unit 150 but may be an operation panel 260 (e.g., a touch screen) provided on a front surface of the processor 200 or a foot pedal connected with the processor 200.

Further, a change in the revolution amplitude of the emission end 112b of the single-mode fiber 112 responsive to an operation of the lever of the operation unit 150 may not necessarily be caused in common between the X-axis and the Y-axis, but respective different changes may be caused therebetween.

The present disclosure relates to the subject matter contained in Japanese Patent Application No. P2009-187144, filed on Aug. 12, 2009, which is expressly incorporated herein by reference in its entirety.

What is claimed is:

1. An optical observation system configured to generate an image of a subject by optically scanning the subject, comprising:
a light source configured to emit light;
an optical fiber configured to transmit therethrough the light emitted by the light source and emit the light from an emission end thereof;
an operation unit;
a vibrator configured to, in response to the operation unit being operated in a predetermined manner, vibrate the emission end of the optical fiber such that the light emitted from the emission end is scanned to depict a scanning trajectory having a distribution within a predetermined scanning range on the subject, the distribution varying depending on the predetermined manner in which the operation unit is operated;
a reflected light detector configured to detect reflected light from the subject that is scanned with the light emitted from the emission end of the optical fiber;
an image signal detector configured to detect image signals generated based on the reflected light, at respective detection moments;
a pixel allocation unit configured to allocate pieces of image data created from the detected image signals into pixel addresses, based on the detection moments when the image signals are detected, respectively; and
an image generator configured to generate the image of the subject with the pieces of image data allocated into the respective pixel addresses.

2. The optical observation system according to claim 1,
wherein the vibrator is configured to, in response to the operation unit being operated in a first manner, vibrate the emission end of the optical fiber such that the light emitted from the emission end is scanned to depict a scanning trajectory that is distributed evenly within the predetermined scanning range on the subject.

3. The optical observation system according to claim 2,
wherein the vibrator is configured to, in response to the operation unit being operated in a second manner different from the first manner, vibrate the emission end of the optical fiber such that the light emitted from the emission end is scanned to depict a scanning trajectory that is distributed with a higher density toward a center of the predetermined scanning range on the subject.

4. The optical observation system according to claim 3,
wherein the vibrator is configured to, in response to the operation unit being operated in a third manner different from the first and second manners, vibrate the emission end of the optical fiber such that the light emitted from the emission end is scanned to depict a scanning trajectory that is distributed with a higher density toward a peripheral boarder region of the predetermined scanning range on the subject.

5. The optical observation system according to claim 1,
wherein the vibrator is configured to, in response to the operation unit being operated in a second manner, vibrate the emission end of the optical fiber such that the light emitted from the emission end is scanned to depict a scanning trajectory that is distributed with a higher density toward a center of the predetermined scanning range on the subject.

6. The optical observation system according to claim 1,
wherein the vibrator is configured to, in response to the operation unit being operated in a third manner, vibrate the emission end of the optical fiber such that the light emitted from the emission end is scanned to depict a scanning trajectory that is distributed with a higher density toward a peripheral boarder region of the predetermined scanning range on the subject.

7. The optical observation system according to claim 1,
wherein the vibrator is configured to, in response to the operation unit being operated in the predetermined manner, vibrate the emission end of the optical fiber such that the emission end revolves around an axis line direction of the optical fiber so as to depict a spiral pattern on a plane perpendicular to the axis line direction with a revolution radius increasing at a predetermined rate during a scanning period in which the light emitted from the emission end is scanned within the predetermined scanning range on the subject.

8. The optical observation system according to claim 2,
wherein the vibrator is configured to, in response to the operation unit being operated in the first manner, vibrate the emission end of the optical fiber such that the emission end revolves around an axis line direction of the optical fiber so as to depict a spiral pattern on a plane perpendicular to the axis line direction with a revolution radius increasing at a constant rate during a scanning period in which the light emitted from the emission end is scanned within the predetermined scanning range on the subject.

9. The optical observation system according to claim 3,
wherein the vibrator is configured to, in response to the operation unit being operated in the second manner, vibrate the emission end of the optical fiber such that the emission end revolves around an axis line direction of the optical fiber so as to depict a spiral pattern on a plane perpendicular to the axis line direction with a revolution radius increasing at an exponential rate during a scanning period in which the light emitted from the emission end is scanned within the predetermined scanning range on the subject.

10. The optical observation system according to claim 4,
wherein the vibrator is configured to, in response to the operation unit being operated in the third manner, vibrate the emission end of the optical fiber such that the emission end revolves around an axis line direction of the optical fiber so as to depict a spiral pattern on a plane perpendicular to the axis line direction with a revolution radius increasing at a logarithmic rate during a scanning period in which the light emitted from the emission end is scanned within the predetermined scanning range on the subject.

11. The optical observation system according to claim 5,
wherein the vibrator is configured to, in response to the operation unit being operated in the second manner, vibrate the emission end of the optical fiber such that the emission end revolves around an axis line direction of the optical fiber so as to depict a spiral pattern on a plane perpendicular to the axis line direction with a revolution radius increasing at an exponential rate during a scanning period in which the light emitted from the emission end is scanned within the predetermined scanning range on the subject.

12. The optical observation system according to claim 6,
wherein the vibrator is configured to, in response to the operation unit being operated in the third manner, vibrate the emission end of the optical fiber such that the emission end revolves around an axis line direction of the optical fiber so as to depict a spiral pattern on a plane perpendicular to the axis line direction with a revolution radius increasing at a logarithmic rate during a scanning period in which the light emitted from the emission end is scanned within the predetermined scanning range on the subject.

13. The optical observation system according to claim 7,
wherein a maximum value of the revolution radius with which the emission end of the optical fiber is revolved by the vibrator during the scanning period is constant regardless of variation of the distribution of the scanning trajectory.

14. The optical observation system according to claim 1,
wherein the predetermined scanning range within which the light emitted from the emission end of the optical fiber is scanned on the subject is constant regardless of variation of the distribution of the scanning trajectory.

15. The optical observation system according to claim 1,
wherein the vibrator comprises:
a piezoelectric actuator disposed near the emission end of the optical fiber; and
a driver configured to control a voltage to be applied to the piezoelectric actuator in response to the operation unit being operated in the predetermined manner.
